(19) United States
(12) Patent Application Publication
(10) Pub. No.: US 2025/0065679 A1
(43) Pub. Date: Feb. 27, 2025

(54) LOWER CONTROL ARM AND LOWER CONTROL ARM ASSEMBLY

(71) Applicant: AM General LLC, South Bend, IN (US)

(72) Inventors: Nathaniel LaTarte, Troy, MI (US); Poparad Hariton, Farmington Hills, MI (US)

(21) Appl. No.: 18/725,178

(22) PCT Filed: Dec. 28, 2022
(86) PCT No.: PCT/US2022/054142

§ 371 Date: Jun. 28, 2024

Related U.S. Application Data
(60) Provisional application No. 63/294,449, filed on Dec. 29, 2021.

(51) Int. Cl. B60G 7/00; B60G 11/16; B60G 13/00; B60G 15/06

(52) U.S. Cl. CPC B60G 7/001; B60G 11/16; B60G 13/005; B60G 15/06; B60G 2204/1244; B60G 2204/129; B60G 2206/124

(57) ABSTRACT

A control arm assembly for a vehicle includes a control arm, a spring seat, a shock absorber mount, and a spring. The control arm has an upper surface, a lower surface, and an opening extending through the upper surface and the lower surface. The spring seat has an upper surface connected to the lower surface of the control arm. The shock absorber mount is connected to the upper surface of the spring seat. The shock absorber has a first end connected to the shock absorber mount. The spring at least partially surrounds the shock absorber and has a first end contacting the upper surface of the spring seat.

This application claims priority of U.S. Provisional Patent Application No. 63/294,449 filed Dec. 29, 2021.

The present invention relates to vehicle control arms, and, in particular to a lower control arm and a lower control arm assembly for a vehicle.

### BACKGROUND OF THE INVENTION

In a vehicle suspension system, a control arm is a suspension link between the chassis structure and the hub that carries a vehicle wheel. In wishbone type suspensions, a control arm is a generally A-shaped or triangular member having two spaced apart inboard arms that connect to the chassis structure. The primary purpose of the control arm is to control movement of the vehicle wheel, not to support the weight of the vehicle. Examples of vehicle control arms are shown in U.S. Pat. Nos. 2,731,257 and 7,278,648.

### SUMMARY OF THE INVENTION

In one embodiment of the present invention, a control arm assembly for a vehicle includes a control arm, a spring seat, a shock absorber and a shock absorber mount. The control arm has an upper surface, a lower surface, a first side, a second side, an opening extending through the upper surface and the lower surface, an outboard end, and an inboard end. The inboard end has a first arm and a second arm. The spring seat has an upper surface connected to the lower surface of the control arm, a lower surface, and an opening extending through the upper surface and the lower surface. The shock absorber mount has a base extending from the upper surface of the spring seat, a first tab extending from the base, and a second tab extending from the base. The shock absorber has a first end having a first mounting structure connected to the first and second tabs of the shock absorber mount, and a second end having a second mounting structure. The spring at least partially surrounds the shock absorber and has a first end contacting the upper surface of the spring seat and a second end.

In one embodiment, the control arm is a lower control arm.

In another embodiment, the opening in the control arm has an irregular perimeter.

In certain embodiments, the control arm includes at least a first member and a second member.

In another embodiment, the control arm assembly further includes a boss extending from the lower surface of the spring seat, a bore extending through the boss, and a fastener extending through the bore and into the lower surface of the control arm.

In other embodiments, the control arm assembly further includes a first opening in the first tab of the shock absorber mount, a second opening in the second tab of the shock absorber mount, an opening in the first mounting structure of the shock absorber, and a fastener extending through the first tab of the shock absorber mount, the second opening in the second tab of the shock absorber mount, and the opening in the first mounting structure of the shock absorber.

In another embodiment, the shock absorber mount and the spring seat are integrally formed.

In certain embodiments, the shock absorber extends into the opening in the control arm.

In some embodiments, the spring extends into the opening in the control arm.

In one embodiment of the present invention, a control arm assembly for a vehicle includes a control arm, a spring seat, a shock absorber mount, and a spring. The control arm has an upper surface, a lower surface, and an opening extending through the upper surface and the lower surface. The spring seat has an upper surface connected to the lower surface of the control arm. The shock absorber mount is connected to the upper surface of the spring seat. The shock absorber has a first end connected to the shock absorber mount. The spring at least partially surrounds the shock absorber and has a first end contacting the upper surface of the spring seat.

In one embodiment, the shock absorber mount further includes a base extending from the upper surface of the spring seat. In certain embodiments, the shock absorber mount further includes a first tab extending from the base, and a second tab extending from the base. In another embodiment, the first end of the shock absorber is connected to the first and second tabs of the shock absorber mount.

In some embodiments, the control arm is a lower control arm.

In another embodiment, the opening in the control arm has an irregular perimeter.

In another embodiment, the control arm assembly further includes a boss extending from the lower surface of the spring seat, a bore extending through the boss, and a fastener extending through the bore and into the lower surface of the control arm.

In another embodiment, the shock absorber mount and the spring seat are integrally formed.

In certain embodiments, the shock absorber extends into the opening in the control arm.

In some embodiments, the spring extends into the opening in the control arm.

One embodiment of the present invention is a method of assembling a control arm assembly for a vehicle. The control arm assembly has a control arm having an upper surface, a lower surface, and an opening extending through the upper surface and the lower surface, a spring seat having an upper surface and a lower surface, a shock absorber mount connected to the upper surface of the spring seat, a shock absorber having a first end and a second end, and a spring having a first end and a second end. The method includes connecting the first end of the shock absorber to the shock absorber mount, positioning the spring around the shock absorber, inserting the shock absorber and spring from beneath the lower surface of the control arm through the opening in the control arm, and securing the spring seat to the lower surface of the control arm.

In one embodiment, the shock absorber and spring are inserted through the opening in the control arm until the upper surface of the spring seat contacts the lower surface of the control arm.

In another embodiment, the method further includes connecting the control arm to a vehicle prior to inserting the shock absorber and spring through the opening in the control arm. In certain embodiments, the method further includes connecting the second end of the shock absorber to the vehicle. In some embodiments, the method further includes subsequently disconnecting the second end of the shock absorber from the vehicle and removing the shock absorber and spring through the opening in the control arm from beneath the lower surface of the control arm while the control arm is connected to the vehicle.

These and other features of the present invention will be apparent to those of skill in the art from the following description and accompanying drawings.

### BRIEF DESCRIPTION OF THE DRAWINGS

FIG. 1 is an exploded perspective view of a lower control arm assembly according to one embodiment of the present invention.

FIG. 2 is a top side perspective view of a lower control arm that is a component of the lower control arm assembly shown in FIG. 1.

FIG. 3 is a bottom side perspective view of the lower control arm shown in FIG. 2.

FIG. 4 is a top side perspective view of a shock absorber mount and spring seat that is a component of the lower control arm assembly shown in FIG. 1.

FIG. 5 is a perspective view of the lower control arm assembly shown in FIG. 1 in a partially assembled configuration.

FIG. 6 is a perspective view of the lower control arm assembly shown in FIG. 1 in a fully assembled configuration.

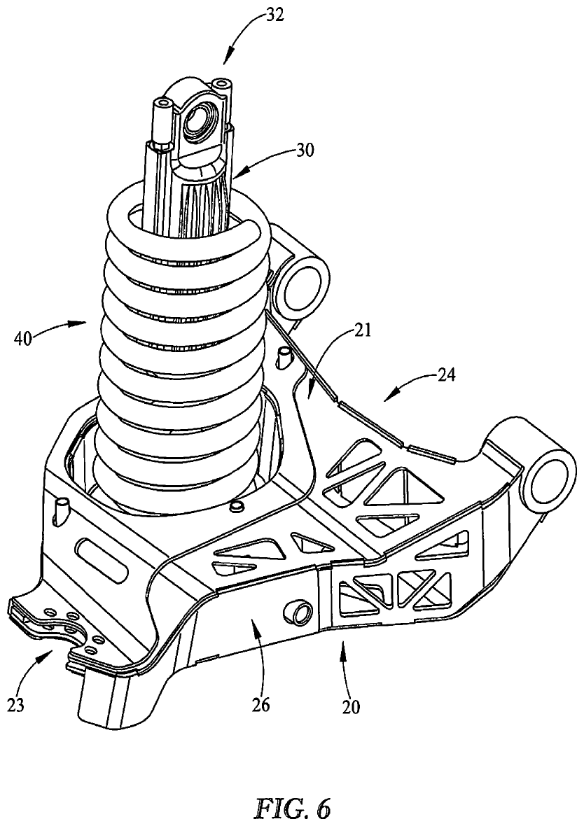

FIG. 7 is a perspective view of the lower control arm shown in FIG. 1 installed on a vehicle.

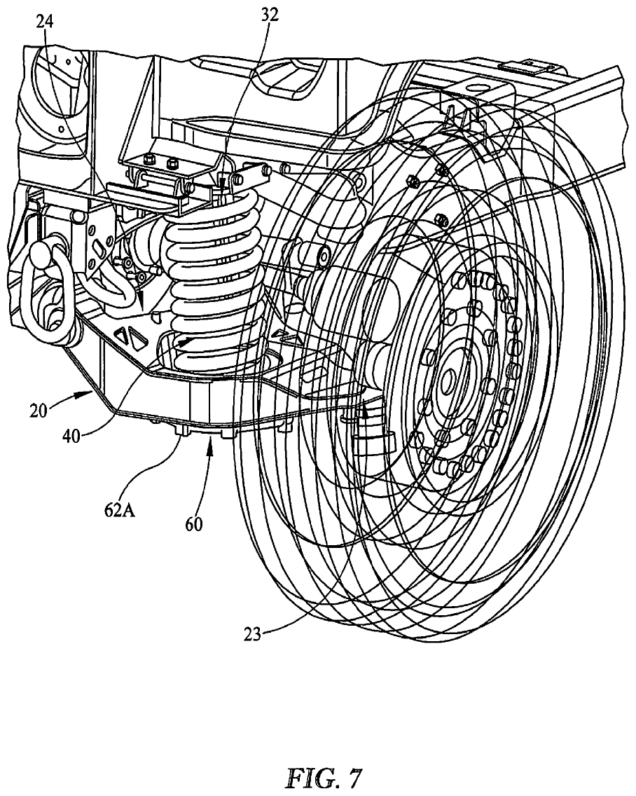

### DETAILED DESCRIPTION OF EMBODIMENTS OF THE INVENTION

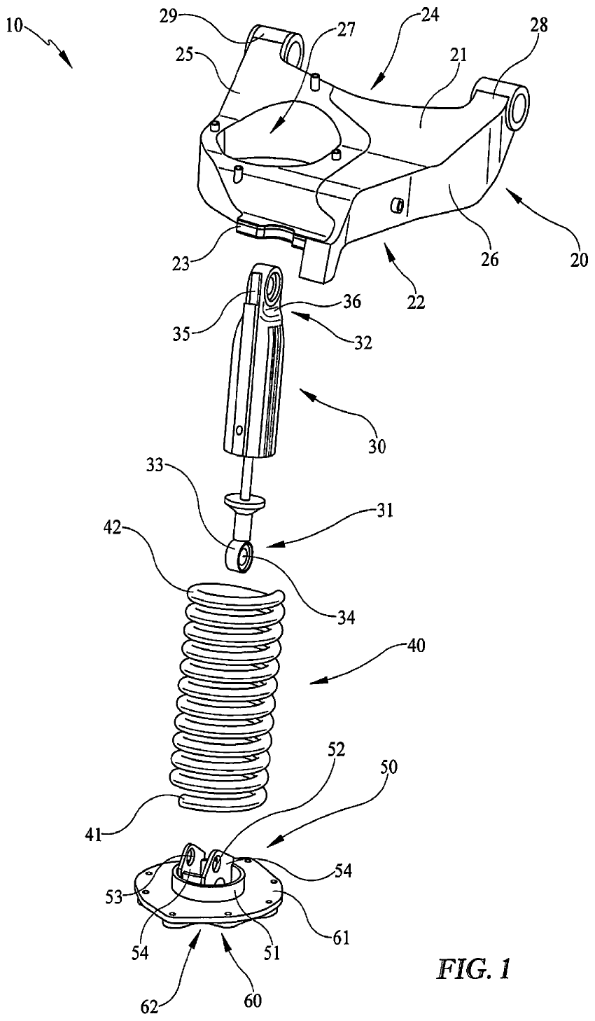

FIG. 1 is an exploded perspective view of a lower control arm assembly according to one embodiment of the present invention. In the embodiment shown, lower control arm assembly 10 generally includes a control arm 20, a shock absorber 30, a spring 40, a shock absorber mount 50, and a spring seat 60.

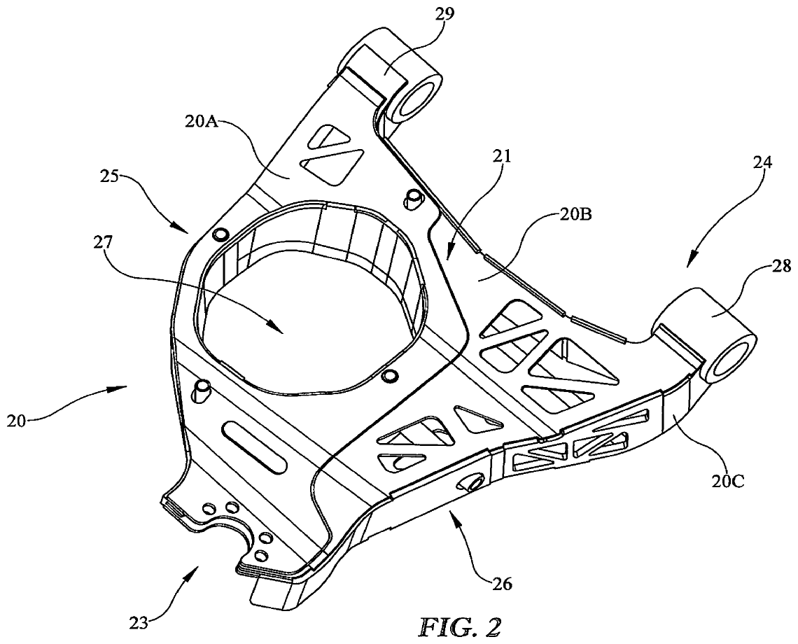

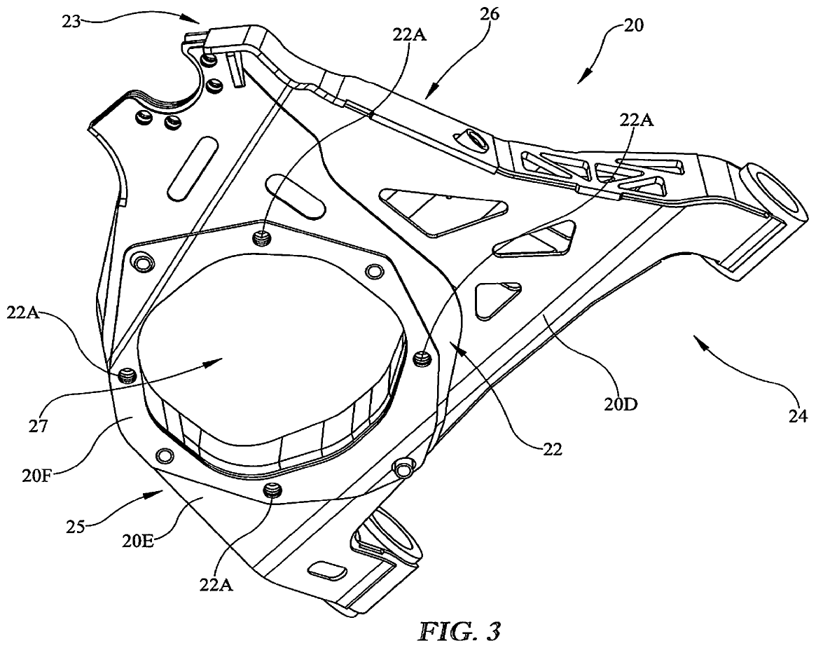

FIG. 2 is a top side perspective view and FIG. 3 is a bottom side perspective view of control arm 20. Control arm 20 can be a cast member or a welded structure. In the embodiment shown, control arm 20 is a welded structure and includes first plate or member 20A, a second plate or member 20B, a third plate or member 20C, a fourth plate or member 20D, a fifth plate or member 20E, and a sixth plate or member 20F. Referring to FIGS. 2 and 3, control arm 20 has an upper surface 21, a lower surface 22, an outboard end 23, an inboard end 24, a first side 25, a second side 26, and an opening or bore 27. Lower surface 22 of control arm 20 includes one or more mounting openings 22A for securing spring seat 60 to lower surface 22 as described below. Outboard end 23 of control arm 20 faces away from the centerline of the vehicle toward a wheel as is known in the art. Inboard end 24 of lower control arm 20 includes a first arm 28 and a second arm 29. First arm 28 and second arm 29 of inboard end 24 of control arm 20 face toward the centerline of the vehicle and connect to the vehicle chassis as is known in the art. Bore 27 extends from upper surface 21 of control arm 20 to lower surface 22 of control arm 20. Bore 27, in the embodiment shown, has an irregular perimeter. The shape of bore 27 can be selected to provide the needed clearances for shock absorber 30 and spring 40 during assembly, suspension travel, maintenance, and use for the particular vehicle with which lower control arm assembly 10 will be used. In other embodiments of the invention, the perimeter of bore 27 is different from than that shown, such as, for example, a circular perimeter.

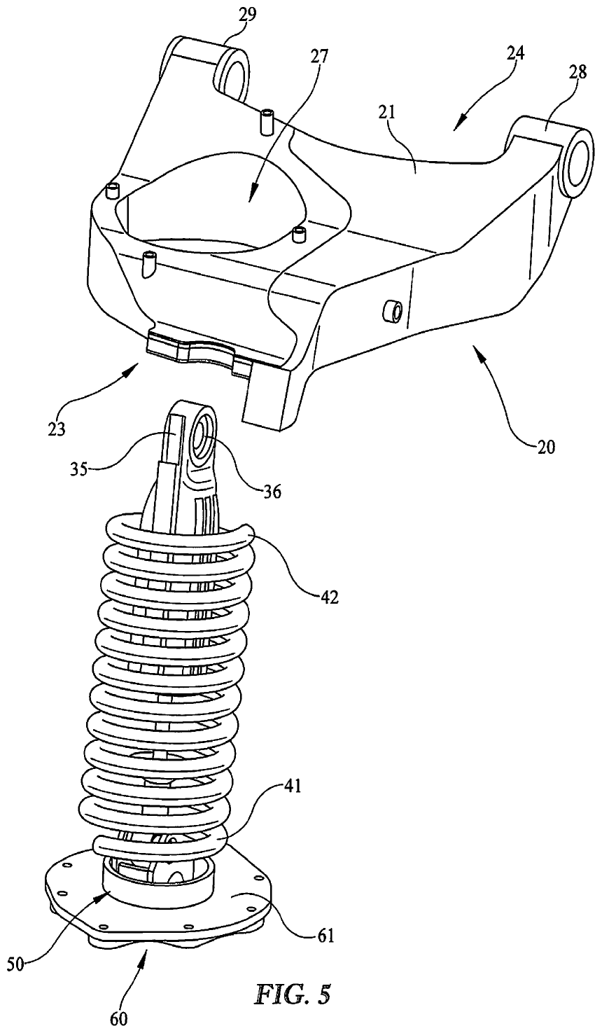

Referring to FIGS. 1 and 5, shock absorber 30 in the embodiment shown has a first end 31 and a second end 32. First end 31 includes a mounting structure 33 having an opening 34 extending therethrough. Opening 34 receives a fastener to secure first end 31 of shock absorber 30 to shock absorber mount 50 as described below. Second end 32 of shock absorber 30 includes a mounting structure 35 having an opening 36 extending therethrough. Opening 36 receives a fastener to secure second end 32 of shock absorber 30 to the vehicle with which lower control arm assembly 10 is utilized. Shock absorber 30 can be any type of shock absorber appropriate for use in the vehicle with which lower control arm assembly 10 will be utilized, taking into consideration the expected or intended operating conditions for the vehicle.

Spring 40 has a first end 41 and a second end 42. Spring 40 and bore 27 of control arm 10 are sized and configured such that spring 40 can pass through bore 27 during assembly or suspension travel of lower control arm assembly 10, as described below. Spring 40 can be any type of spring appropriate for use in the vehicle with which lower control arm assembly 10 will be utilized, taking into consideration the expected or intended operating conditions for the vehicle.

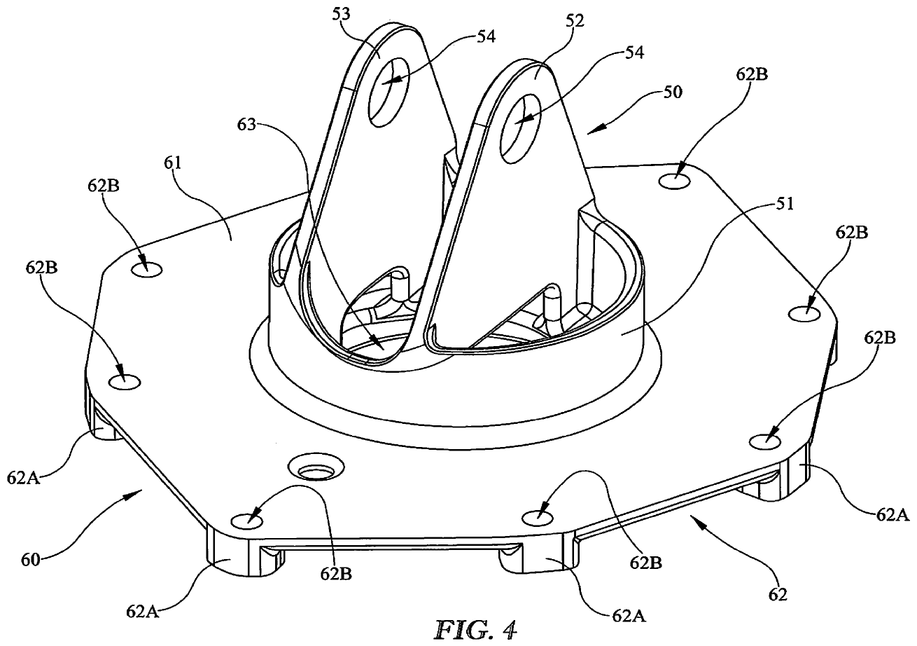

As shown in FIGS. 1 and 4, shock absorber mount 50, in the embodiment shown, has a base 51, a first ear or tab 52, and a second ear or tab 53. Base 51 is configured in the embodiment shown as a short ring or cylinder. First tab 52 and second tab 53 extend from bas 51 and include openings 54. Openings 54 receive a fastener for connecting shock absorber 30 to shock absorber mount 50 as described below.

Referring to FIGS. 1 and 4, spring seat 60 in the embodiment shown, is a substantially plate like member having an upper surface 61, a lower surface 62, and an opening or bore 63. One or more bosses 62A extend from lower surface 62. Each boss 62A includes a through bore or mounting opening 62B for receiving fasteners to secure spring seat 60 to control arm 20 as described below. Bore 63 extends from upper surface 61 of spring seat 60 to lower surface 62 of spring seat 60.

Referring to FIG. 5, to assemble lower control arm assembly 10, first end 31 of shock absorber 30 is secured to shock absorber mount 50 by inserting a bolt or other fastener through openings 54 in first tab 52 and second tab 53 of shock absorber mount 50 and through opening 34 in first end 31 of shock absorber 30. The bolt can be secured by a nut. Other fasteners may be used instead of a bolt and secured in the appropriate manner. Spring 50 is then placed around shock absorber 30 such that first end 41 rests on upper surface 61 of spring seat 60. Shock absorber 30 and spring 40 are then inserted toward second surface 22 of control arm 20 and through bore 27 until upper surface 61 of spring seat 60 contacts lower surface 22 of control arm 20. Mounting openings 62B are aligned with mounting openings 22A in lower surface 22 of control arm 20, and spring seat 60 is secured to lower surface 22 of control arm 20 by inserting appropriate fasteners into mounting openings 62B and mounting openings 22A.

With the configuration shown, shock absorber 30 and spring 40 can be inserted into and removed from bore 27 of lower control arm 20 from one side (i.e., the lower side) of control arm 20 as a single unit. The placement of spring seat 60 below the lower surface of control arm 20 also permits use of longer springs as compared to control arm assemblies that utilize a spring seat located above the lower surface of the control arm.

Although embodiments of the invention have been shown and described in detail, the same is for purposes of illustration only and is not a limitation on the scope of the invention. Numerous modifications can be made to the embodiments shown and described without departing from the scope of the invention. For example, control arm 20, shock absorber mount 50, and spring seat 60 can have configurations other than those illustrated and described above. Shock absorber mount 50 and spring seat 60 can be formed as separate components and joined together, such as by welding, as opposed to being formed as a single member as shown. Shock absorbers and springs other than those shown and described can also be utilized in lower control arm assemblies of the present invention. Other modifications are also within the scope of the invention.

What is claimed is:

1. A control arm assembly for a vehicle, including:
a control arm having an upper surface, a lower surface, a first side, a second side, an opening extending through the upper surface and the lower surface, an outboard end, and an inboard end, the inboard end having a first arm and a second arm;
a spring seat having an upper surface connected to the lower surface of the control arm, a lower surface, and an opening extending through the upper surface and the lower surface;
a shock absorber mount having a base extending from the upper surface of the spring seat, a first tab extending from the base, and a second tab extending from the base;
a shock absorber having a first end having a first mounting structure connected to the first and second tabs of the shock absorber mount, and a second end having a second mounting structure; and
a spring at least partially surrounding the shock absorber, the spring having a first end contacting the upper surface of the spring seat and a second end.

2. The control arm assembly according to claim 1, wherein the control arm is a lower control arm.

3. The control arm assembly according to claim 1, wherein the opening in the control arm has an irregular perimeter.

4. The control arm assembly according to claim 1, wherein the control arm includes at least a first member and a second member.

5. The control arm assembly according to claim 1, further including a boss extending from the lower surface of the spring seat, a bore extending through the boss, and a fastener extending through the bore and into the lower surface of the control arm.

6. The control arm assembly according to claim 1, further including a first opening in the first tab of the shock absorber mount, a second opening in the second tab of the shock absorber mount, an opening in the first mounting structure of the shock absorber, and a fastener extending through the first tab of the shock absorber mount, the second opening in the second tab of the shock absorber mount, and the opening in the first mounting structure of the shock absorber.

7. The control arm assembly according to claim 1, wherein the shock absorber mount and the spring seat are integrally formed.

8. The control arm assembly according to claim 1, wherein the shock absorber extends into the opening in the control arm.

9. The control arm assembly according to claim 1, wherein the spring extends into the opening in the control arm.

10. A control arm assembly for a vehicle, including:
a control arm having an upper surface, a lower surface, and an opening extending through the upper surface and the lower surface;
a spring seat having an upper surface connected to the lower surface of the control arm;
a shock absorber mount connected to the upper surface of the spring seat;
a shock absorber having a first end connected to the shock absorber mount; and
a spring at least partially surrounding the shock absorber and having a first end contacting the upper surface of the spring seat.

11. The control arm assembly according to claim 10, wherein the shock absorber mount further includes a base extending from the upper surface of the spring seat.

12. The control arm assembly according to claim 11, wherein the shock absorber mount further includes a first tab extending from the base, and a second tab extending from the base.

13. The control arm assembly according to claim 12, wherein the first end of the shock absorber is connected to the first and second tabs of the shock absorber mount.

14. The control arm assembly according to claim 10, wherein the control arm is a lower control arm.

15. The control arm assembly according to claim 10, wherein the opening in the control arm has an irregular perimeter.

16. The control arm assembly according to claim 10, further including a boss extending from the lower surface of the spring seat, a bore extending through the boss, and a fastener extending through the bore and into the lower surface of the control arm.

17. The control arm assembly according to claim 10, wherein the shock absorber mount and the spring seat are integrally formed.

18. The control arm assembly according to claim 10, wherein the shock absorber extends into the opening in the control arm.

19. The control arm assembly according to claim 10, wherein the spring extends into the opening in the control arm.

20. A method of assembling a control arm assembly for a vehicle, the control arm assembly having a control arm having an upper surface, a lower surface, and an opening extending through the upper surface and the lower surface, a spring seat having an upper surface and a lower surface, a shock absorber mount connected to the upper surface of the spring seat, a shock absorber having a first end and a second end, and a spring having a first end and a second end, the method including:
connecting the first end of the shock absorber to the shock absorber mount;
positioning the spring around the shock absorber;
inserting the shock absorber and spring from beneath the lower surface of the control arm through the opening in the control arm; and
securing the spring seat to the lower surface of the control arm.

21. The method of assembling a control arm assembly according to claim 20, wherein the shock absorber and spring are inserted through the opening in the control arm until the upper surface of the spring seat contacts the lower surface of the control arm.

22. The method of assembling a control arm assembly according to claim 20, further including connecting the control arm to a vehicle prior to inserting the shock absorber and spring through the opening in the control arm.

23. The method of assembling a control arm assembly according to claim 22, further including connecting the second end of the shock absorber to the vehicle.

24. The method of assembling a control arm assembly according to claim 23, further including, subsequently disconnecting the second end of the shock absorber from the vehicle and removing the shock absorber and spring through the opening in the control arm from beneath the lower surface of the control arm while the control arm is connected to the vehicle.
